(19) United States
(12) Patent Application Publication
(10) Pub. No.: US 2007/0084332 A1
(43) Pub. Date: Apr. 19, 2007

(54) Crib toy

(76) Inventor: Abbey C. Blaszczyk, Los Angeles, CA (US)

Correspondence Address: KONRAD RAYNES & VICTOR, LLP, 315 S. BEVERLY DRIVE, # 210, BEVERLY HILLS, CA, 90212, US

(21) Appl. No.: 11/254,313

(22) Filed: Oct. 19, 2005

(51) Int. Cl. G10H 1/00

(52) U.S. Cl. 84/600

(57) ABSTRACT

Provided are a method and system for entertaining, educating or calming an infant or other individual, which includes a panel-shaped member having a plurality of user selectable switches by which a user may select musical segments having various musical styles for output by the member. Other user selectable switches permit selection of tones of a musical scale for play. In one embodiment, the member may be attached to a crib of an infant. Additional embodiments are described and claimed.

### BACKGROUND

Various devices have been proposed for entertaining or calming an infant or small child. Some devices provide music or a pleasing visual effect, or both. Music may be provided by a music synthesizer or a mechanical music box. Visual effects include static displays of ornamental features. Other devices provide rotating or animated displays. Some devices are capable of projecting images on a nursery wall. Other known visual effects include the use of light bulbs, water filled globes or light emitting fiber optic strands.

These devices can also often provide an educational function as well as entertainment or calming. Some devices are in the form of a panel which attaches to a rail of the infant's crib. These panels may have one or more features to draw the attention of an infant. For example, a push button may be provided which plays a musical tone or a prerecorded selection.

### BRIEF DESCRIPTION OF THE DRAWINGS

FIG. 1 is a front elevation view of an example of one system in accordance with the present description.

FIG. 2 is a partial cross-sectional view of the member of FIG. 1 as viewed along the line 2-2 of FIG. 1.

FIG. 3 is a partial cross-sectional view of the member of FIG. 1 as viewed along the line 3-3 of FIG. 1.

FIG. 4 is a rear elevation view of an example of one system accordance with the present description.

FIG. 5 is a partial cross-sectional view of the member of FIG. 1 as viewed along the line 5-5 of FIG. 1.

FIG. 6 is a partial cross-sectional view of the member of FIG. 1 as viewed along the line 6-6 of FIG. 1.

FIG. 7 is a partial cross-sectional view of the member of FIG. 1 as viewed along the line 7-7 of FIG. 1.

FIG. 8 is a partial cross-sectional view of the member of FIG. 1 as viewed along the line 8-8 of FIG. 1.

FIG.9 is a partial cross-sectional view of the member of FIG. 1 as viewed along the line 9-9 of FIG. 1.

FIG. 10 is a partial cross-sectional view of the member of FIG. 1 as viewed along the line 10-10 of FIG. 1.

FIG. 11 is a schematic diagram of one embodiment of a controller of the system of FIG. 1.

### DETAILED DESCRIPTION

In the following description, reference is made to the accompanying drawings which form a part hereof and which illustrate several embodiments. It is understood that other embodiments may be utilized and structural and operational changes may be made without departing from the scope of the descriptions provided.

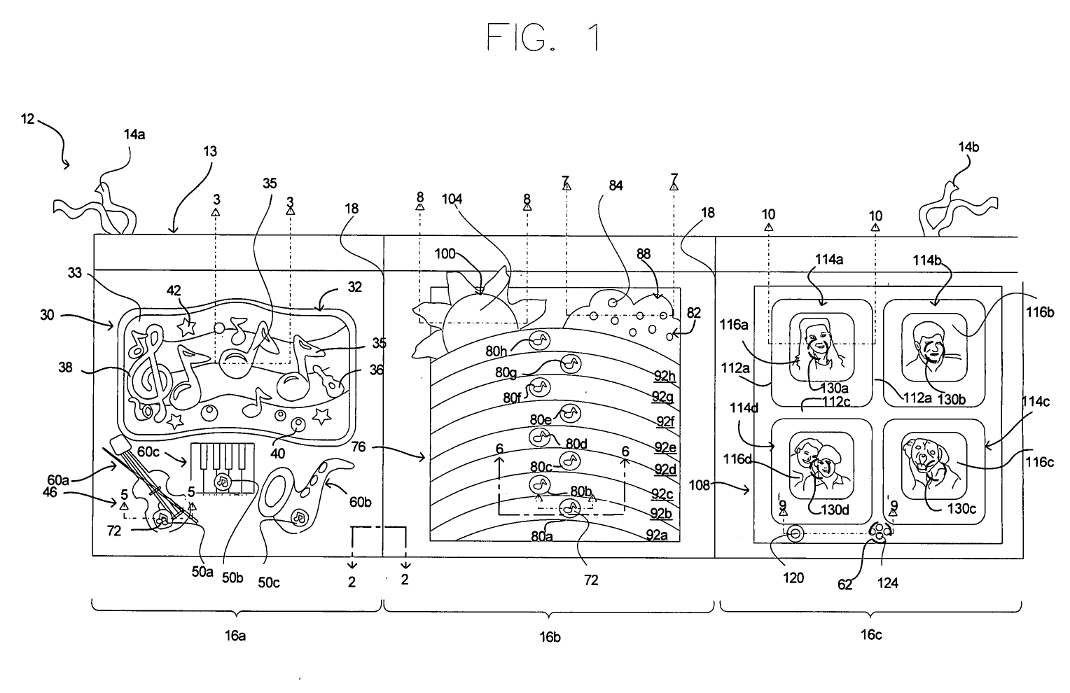

FIG. 1 illustrates one example of a system 12 for entertaining, calming or educating an infant or small child. It is appreciated however that a system in accordance with the present description may be utilized for other applications including room decorations. In the illustrated embodiment, the system 12 is a toy which includes a generally flat, rectangular member 13 having ribbon shaped ties 14a, 14b at two opposite upper corners of the member 13. The ties 14a, 14b permit the member 13 to be tied to a room furnishing such as an infant's crib, so that the member 13 is presented to the user in a generally upright position. It is appreciated that other types of fasteners may be utilized, depending upon the particular application. For example, velcro and snap fastened straps may be utilized as well.

In the illustrated embodiment, the member 13 comprises three generally rigid panels 16a, 16b, 16c, joined together side by side by living hinges 18 between adjoining panels 16a, 16b and 16b, 16c. FIG. 1 illustrates the member 13 in the fully opened position in which the three panels 16a, 16b, 16c are generally coplanar. The living hinges 18 permit the three panels 16a, 16b, 16c to be folded for storage. In the fully folded position, the length of the member 13 is approximately one third that shown in FIG. 1 to reduce its size for storage.

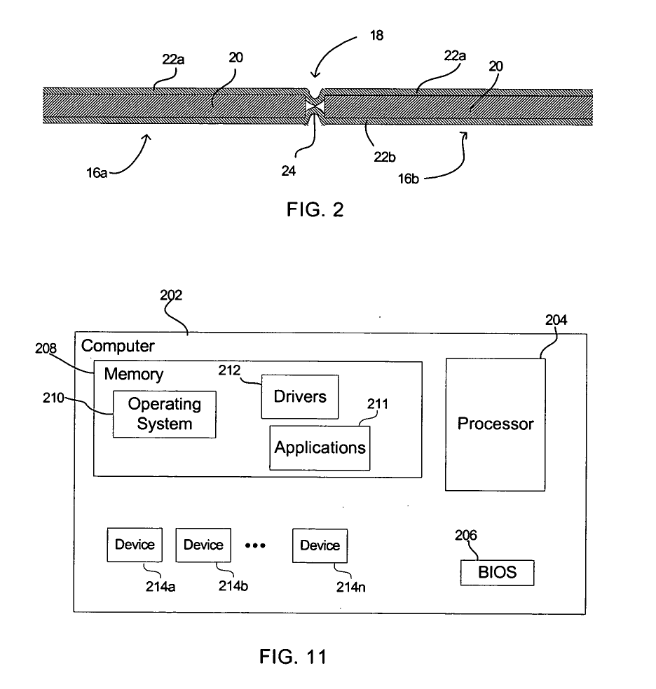

As best seen in the cross-sectional view of FIG. 2 and as represented by the panels 16a, 16b of FIG. 2, each panel 16a, 16b, 16c includes a relatively rigid substrate 20 made of plastic, or another suitable material. Each substrate 20 may be covered with a front outer layer 22a and a rear outer layer 22b, each of which may be formed of a soft, flexible material such as a fabric covering, for example. The fabric of the outer layers 22a, 22b may be printed with colorful decorations. The living hinges 18 may be formed of the same front and rear outer layers 22 extending between adjacent substrates 20 and joined in a seam 24 between adjacent substrates 20. The seam 24 may be joined by stitching or other suitable fasteners. It is appreciated that the substrates 20 and outer layers 22a, 22b may be formed of other materials, depending upon the particular application. It is further appreciated that the hinges 18 may be formed using other techniques.

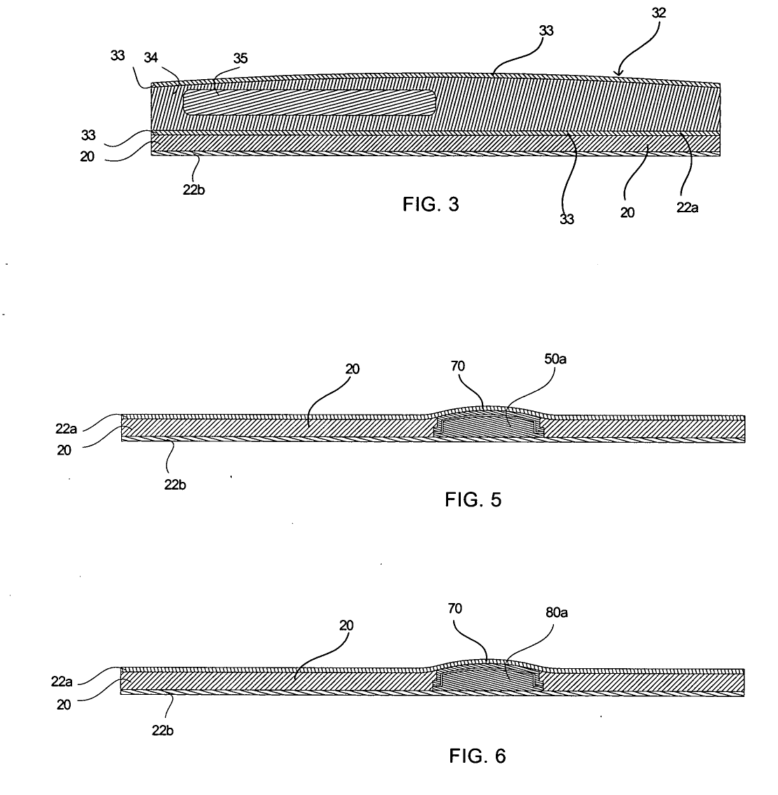

The front outer surface 22a of the member 13 faces in toward the infant in the crib when the member 13 is attached to the crib railing. The front surface 22a comprises a plurality of touchable areas providing tactile, visual and audio feedback to the infant in the crib. As viewed in FIG. 1, the left panel 16a has a touchable area 30 which includes a transparent pouch 32 comprising a fluid tight flexible membrane 33 (FIG. 3) which forms a fluid tight pouch. A clear fluid 34 contained with the member 33 provides suspension for floating objects having a variety of shapes, such as musical note shaped objects 35, musical instrument shaped objects 36, musical symbol shaped objects 38, spherical shaped objects 40, star shaped objects 42 or other shapes. The objects may be pushed around within the fluid 34 as the infant or other user manually depresses the member 33, providing an interesting and entertaining experience. The fluid 34 may be water, a gel, alcohol, oil or any other suitable fluid. The member 33 may be plastic or any other suitable material. The pouch 32 is optional. Other tactile and visual stimulation devices may be provided.

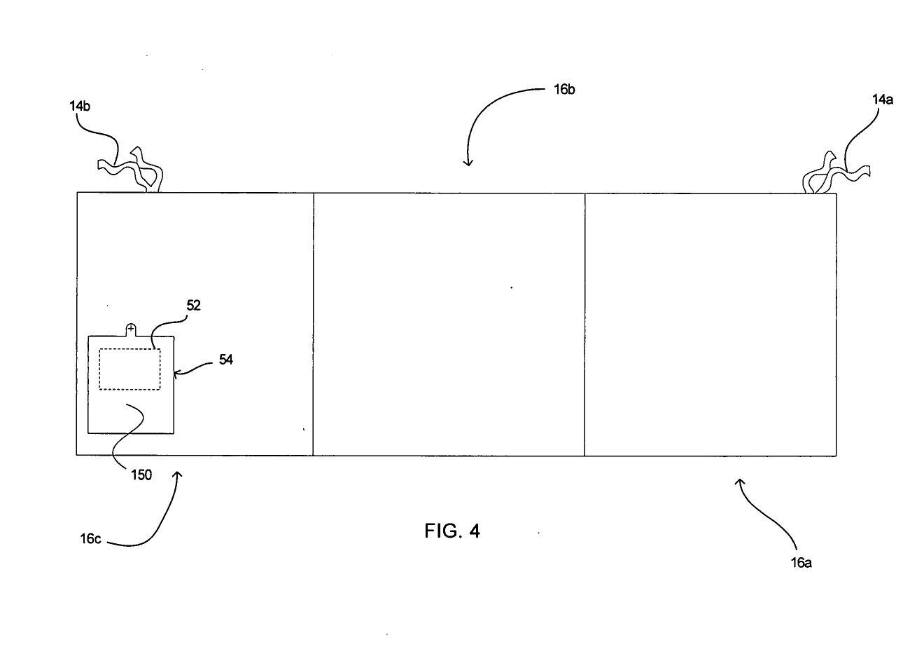

The left panel 16a also includes an audio and visual stimulation area 46 which includes three push button switches 50a, 50b, 50c electrically coupled to a controller 52 (FIG. 4) housed in a compartment 54 positioned at the rear of the member 13. The first push button switch 50a is visually presented in the vicinity of an indicia 60a representing a violin. A second push button switch 50b is similarly positioned adjacent to an indicia 60b representing a saxophone. A third push button switch 50c is likewise positioned adjacent to an indicia 60c representing a plurality of piano keys. The indicia 60a, 60b, 60c also represent different musical styles. Thus, in this example, the violin indicia 60a represents classical style music, the saxophone indicia 60b represents jazz style music, and the piano key indicia 60c represents lullaby style music. When one of the button switches 50a, 50b, 50c is depressed by the user, the selection of a particular musical style by the user is detected by the controller 52 and a pre-recorded audio segment in the selected musical style is played through a speaker 62 housed within the right panel 16c. Thus, if the controller 52 detects the depression of the push button switch 50a visually associated with the violin indicia 60a representing the classical musical style, an audio segment in the classical musical style is played. Similarly, if the controller 52 detects the depression of the push button switch 50b visually associated with the saxophone indicia 60b representing the jazz musical style, an audio segment in the jazz musical style is played. Also, if the controller 52 detects the depression of the push button switch 50c visually associated with the piano key indicia 60c representing the lullaby musical style, an audio segment in the lullaby musical style is played. It is appreciated that a greater or lesser number of musical style switches may be provided. It is further appreciated that other musical styles may be played as well.

FIG. 5 is a cross-sectional view of one of the switches 50a disposed in the substrate 20 with a portion 70 of the fabric outer layer 22a disposed over the push button switch 50a. Indicia such as the musical note indicia 72, for example, may be printed on the portion 70 to indicate the location of each underlying push button switch 50a, 50b, 50c. It is appreciated that other types of user selectable inputs may be provided.

The middle panel 16b comprises a tactile, audio and visual stimulation area 76 which includes second plurality of push button switches 80a-80h and a plurality of light emitting diodes (LED's) 82. In a manner similar to the switches 50a-50c, the switches 80a-80h are, as represented by the switch 80a of FIG. 6, disposed in the substrate 20 with a portion 70 of the fabric outer layer 22a disposed over the push button switches 80a-80h. Indicia such as the musical note indicia 72, for example, may be printed on the portion 70 to indicate the location of each underlying push button switch 80a-80h. It is appreciated that other types of user selectable inputs may be provided.

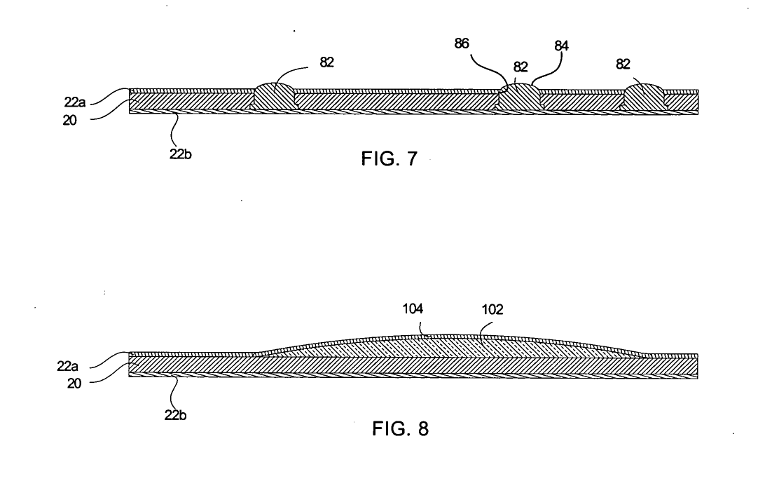

The LED's 82 are mounted in the substrate 20 as represented by the cross-sectional view of three LED's 82 shown in FIG. 7. Each LED 82 has a portion 84 which extends through an aperture 86 in the fabric front outer layer 22a, exposing the portion 84 to view by the user. A two dimensional decoration 88 (FIG. 1) may be printed on the exterior of the fabric front outer layer 22a adjacent the LED's 82. In the illustrated embodiment, the decoration 88 represents clouds. It is appreciated that other visually pleasing decorations may be positioned adjacent the LED's 82.

Another two dimensional decoration 90 (FIG. 1) may be printed on the exterior of the fabric front outer layer 22a adjacent the push button switches 80a-80h. In the illustrated embodiment, the decoration 90 represents a rainbow having a plurality of color bands 92a-92h, each color band surrounding an associated push button switch 80a-80h. It is appreciated that other visually pleasing decorations may be positioned adjacent the switches 80a-80h.

In the illustrated embodiment, the push button switches 80a-80h and the color bands 92a-92h are provided to represent tones on a musical scale. The eight buttons and colors represent an eight tone musical scale. When one of the button switches 80a-80hc is depressed by the user, the selection of a particular musical tone by the user is detected by the controller 52 and a pre-recorded audio segment of a musical tone of the musical scale is played through the speaker 62 housed within the right panel 16c. Thus, if the controller 52 detects the depression of the push button switch 80a associated with the lowest color band 92a representing the lowest tone of the musical scale, an audio segment of the lowest tone is played. Similarly, if the controller 52 detects the depression of the push button switch 80b associated with the next higher color band 92b representing the next higher musical tone of the musical scale, an audio segment of the next higher tone is played. The remaining tones of the musical scale may be played by depressing the corresponding push button 80c-80h. It is appreciated that a greater or lesser number of musical tone switches and associated color bands may be provided. It is further appreciated that other musical scales may be played as well.

When one button switch 80a-80h is pressed, the LED's 82 blink on and off to emit pulses of light. It is appreciated that other types of light sources may be used and other types of visual stimulation may be provided to accompany the tones of the musical scale. In an alternative embodiment, the light stimulation LED's may be omitted or another stimulation area substituted.

Additional tactile feedback of the area 76 on the middle panel 16b is provided by a three dimensional decoration 100. In the illustrated embodiment, the decoration 100 includes a compressible core 102 (FIG. 8) disposed on the substrate 20. The core 102 may be made of a compressible material such as foam or other suitable compressible materials. In addition, the compressible core 102 may be covered with a crinkle paper 104 that, when touched, produces an interesting crinkling sound. The crinkle paper 104 and the surrounding fabric front outer layer 22a may be printed with a pleasing visual image such as an image of the sun, for example. It is appreciated that other types of decorations and audio and tactile materials may be substituted for the decoration 100 and the crinkle paper 104.

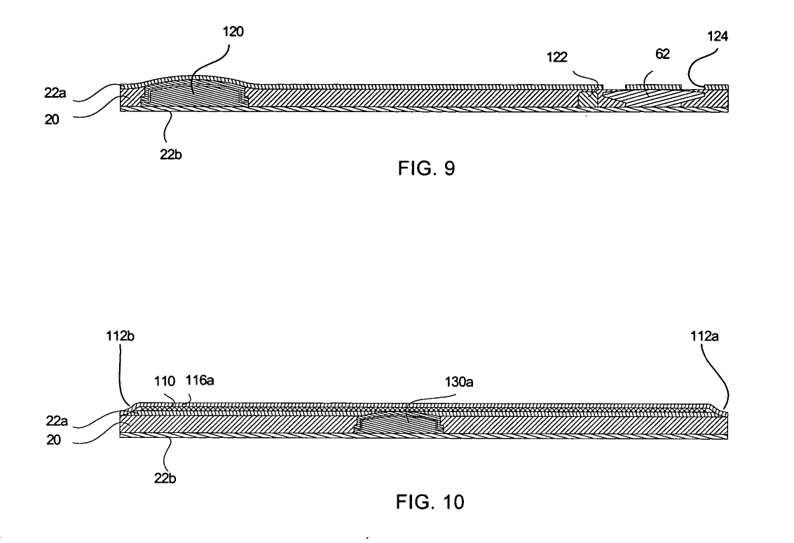

The right panel 16c provides an audio and visual stimulation area 108 for the infant to view family photographs and to play back pre-recorded voice messages through the speaker 62 (FIG. 9). A flat rectangular sheet 110 (FIG. 10) of a clear flexible material, such as plastic, may be sewn along its right edge 112a, left edge 112b, and lower edge 112c (FIG. 1) forming a clear window pocket 114a (FIG. 1). A photograph or picture 116a printed on paper or other suitable substrate may be trimmed to fit and then slipped into the pocket 114a beneath the window sheet 110. In the illustrated embodiment, three additional similar pockets 114b, 114c, 114d may be arranged on the right panel 16c. A record button switch 120, a microphone 122 and the speaker 62 are disposed on the substrate 20 of the same panel 16c as shown in FIG. 9. The front outer layer 22a may have perforations 124 to facilitate the passage of the output of the speaker 62 to the front of the member 13. When the record button switch 120 is depressed by the user, the controller 52 allows a voice audio message to be recorded by a parent or other individual by an audio recording circuit the controller 52 for each of the four pictures 116a-116d.

A push button switch 130a, 130b, 130c, 130d is disposed beneath each of the pictures 116a, 116b, 116c, 116d, respectively. FIG. 11 shows, for example, push button switch 130a disposed in the substrate 20 with a portion 132 of the fabric outer layer 22a disposed over the push button switch 130a. The pocket 114a is positioned over the portion 132 to indicate the location of the underlying push button switch 130a. It is appreciated that other types of user selectable inputs may be provided.

When one of the button switches 130a, 130b, 130c, 130d is depressed by the user, the selection of a particular overlying picture 116a-116d by the user is detected by the controller 52 and a pre-recorded audio segment of the pictured individual may be played through the speaker 62 housed within the right panel 16c. Thus, if, for example, the controller 52 detects the depression of the push button switch 130a associated with the picture 116a, the voice recording of that particular individual may be played. It is appreciated that a greater or lesser number of individual selection switches and associated picture pockets pocket 114a-114d may be provided. It is further appreciated that pictures or indicia of other objects such as animals or vehicles, for example, may be placed in the pockets 114a-114d, and the sounds associated with each such object may be recorded for playback when the associated push button switch 130a-130d below that indicia is depressed. In an alternative embodiment the stimulation area 108 may be omitted or another area substituted.

The compartment 54 (FIG. 4) on the rear of the member 13 may have a removable access door 150 to provide access to the system electronics including the controller 52. The compartment 54 may also store batteries to power the controller 52.

FIG. 11 illustrates one example of a computing environment which may be used with the described embodiments. In this embodiment, the controller 52 may comprise a computer 202 which includes a processor 204 (such as one or more central processing units (CPU)), a basic input/output system (BIOS) 206 including code executed by the processor 204 to initialize and control various computer 202 components (e.g., input circuits for push button switches, audio input circuits for a microphone, light output circuits and music or speech synthesizer and recorded audio output circuits) during a boot sequence. In alternative embodiments, the computer components may include a keyboard, display screen, disk drives, serial communications, etc.) The computer 202 includes a memory 208, comprising one or more volatile memory devices, such as volatile random access memory (RAM), in which an operating system 210, an application 211, and one or more drivers 212, such as a device driver interfacing with an attached device 214a, 214b . . . 214n, may be loaded into the memory 208 implementing a runtime environment. In some applications, the memory 208 may further include nonvolatile memory (e.g., a flash memory, Electronically Erasable Programmable Memory (EEPROM), optical disk drives, magnetic disk drives etc.) for storing data such as application data, light pattern data, speech data, voice recording data and music data. The nonvolatile memory may in one embodiment, be removable or updateable to permit substitute application data, speech data, voice recording data or music data to be provided to the computer 202.

Each device 214a, 214b, . . . 214n may comprise any type of Input/Output (I/O) device internal or external to the member 13 of the system 12, such as the input switches 50a-50c, 80a-80h, 120, 130a-13d, recorded audio output circuits, music and speech synthesizer audio output circuits, speaker 62, LED light output circuits, etc.

In other embodiments, the devices 214a, 214b, . . . 214n may comprise a hard disk drive, or a video chipset, for example which may be integrated on the computer 202 motherboard or on an expansion card inserted in an expansion slot on the computer 202 motherboard. The BIOS 206 may be implemented in firmware in a non-volatile memory device on the computer 202 motherboard, such as a Flash memory, Read Only Memory (ROM), Programmable ROM (PROM), etc. The BIOS 206 code indicates the sequence of the boot operations. The operating system 210 may comprise a suitable operating system, such as a Microsoft® Windows® operating system, Linux™, Apple® Macintosh®, etc. (Microsoft and Windows are registered trademarks of Microsoft Corporation, Apple and Macintosh are registered trademarks of Apple Computer, Inc., and Linux is a trademark of Linus Torvalds). In the illustrated embodiment, the controller 52 including the computer 202 are disposed within the compartment 54 of the system 10. However, it is appreciated that the controller 52 may comprise any computing device known in the art, such as a mainframe, server, personal computer, workstation, laptop, handheld computer, telephony device, network appliance, virtualization device, programmable or dedicated circuit, etc. Any suitable CPU or processor 204 or operating system may be used.

In the illustrated embodiment, power is provided by rechargeable or disposable batteries. In an alternative embodiment, power may be provided by a standard A/C wall plug with an in-line transformer.

### Additional Embodiment Details

The described operations may be implemented as a method, apparatus or article of manufacture using standard programming and/or engineering techniques to produce software, firmware, hardware, or any combination thereof. The term “article of manufacture” as used herein refers to code or logic implemented in a tangible medium, where such tangible medium may comprise hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The tangible medium in which the code or-logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made to this configuration without departing from the scope of the present description, and that the article of manufacture may comprise any suitable information bearing medium.

In the illustrated embodiment, images and decorations may be provided on the member 13 by printing images and decorations on the fabric layers 22a, 22b. It is appreciated that decorations and images may be disposed on the member utilizing other techniques including adhesives, sewing and other fasteners and decorating techniques.

In the illustrated embodiment, the member 13 has three panels. It is appreciated that in other embodiments, a greater or lesser number of panels may be provided. In addition, hinges may be omitted such that the member 13 does not fold.

The foregoing description of various embodiments has been presented for the purposes of illustration. It is not intended to be exhaustive or to limit to the precise form disclosed. Many modifications and variations are possible in light of the above teaching.

What is claimed is:

1. A method, comprising:
detecting on a panel device attached to a crib for an infant, a user selection of one of a plurality of user selectable inputs, each input being associated with a unique musical style; and
in response to said detecting, playing a musical segment through said panel device wherein said musical segment has a musical style associated with said detected selected input.

2. The method of claim 1 wherein an input of said plurality of inputs is associated with a jazz musical style, said detecting includes detecting user selection of said jazz input; and said playing includes playing a jazz style musical segment in response to said detected selected jazz input.

3. The method of claim 1 wherein an input of said plurality of inputs is associated with a classical musical style, said detecting includes detecting user selection of said classical input; and said playing includes playing a classical style musical segment in response to said detected selected classical input.

4. The method of claim 1 wherein an input of said plurality of inputs is associated with a lullaby musical style, said detecting includes detecting user selection of said lullaby input; and said playing includes playing a lullaby style musical segment in response to said detected selected lullaby input.

5. The method of claim 1 further comprising:
detecting on said panel a user selection of one of a second plurality of user selectable inputs, each input of said second plurality being associated with a unique musical tone of a musical scale; and
in response to said detecting a user selection of one of said second plurality of selectable inputs, playing a musical tone through said panel device wherein said musical tone is associated with said detected selected input of said second plurality of inputs.

6. The method of claim 5 further comprising, in response to said detecting a user selection of one of said second plurality of selectable inputs, emitting a pulse of light from each of a plurality of light sources.

7. The method of claim 1 further comprising suspending a plurality of objects in a fluid enclosed in a flexible, at least partially transparent pouch carried by said panel device wherein said objects are floating within said pouch and are at least partially visible to a user through said pouch.

8. The method of claim 1 wherein at least some of said objects have the shape of a musical note.

9. The method of claim 1 wherein at least some of said objects have the shape of a musical instrument.

10. The method of claim 1 further comprising presenting a surface of a crinkle paper covering a compressible material wherein in response to a user touch of said surface which flexes said crinkle paper and compresses said compressible material, a crinkling sound is emitted by said crinkle paper.

11. The method of claim 5 further comprising detecting on said panel a user selection of an input of a third plurality of user selectable inputs, each input of said third plurality being associated with an individual; and in response to said detecting a user selection of one of said third plurality of selectable inputs, playing a recording of a voice through said panel device wherein said voice is the voice of the individual associated with said detected selected input of said third plurality of inputs.

12. A device, comprising:
a panel adapted to be attached to a crib for an infant, said panel having an audio output circuit, a plurality of user selectable inputs, each input being associated with a unique musical style; said panel further having control logic adapted to detect a user selection of one of said plurality of user selectable inputs, and in response to said detecting, play a musical segment through said audio output circuit wherein said musical segment has a musical style associated with said detected selected input.

13. The device of claim 12 wherein an input of said plurality of inputs is associated with a jazz musical style, said detecting includes detecting user selection of said jazz input; and said playing includes playing a jazz style musical segment in response to said detected selected jazz input.

14. The device of claim 12 wherein an input of said plurality of inputs is associated with a classical musical style, said detecting includes detecting user selection of said classical input; and said playing includes playing a classical style musical segment in response to said detected selected classical input.

15. The device of claim 12 wherein an input of said plurality of inputs is associated with a lullaby musical style, said detecting includes detecting user selection of said lullaby input; and said playing includes playing a lullaby style musical segment in response to said detected selected lullaby input.

16. The device of claim 12 further comprising:
a second plurality of user selectable inputs on said panel, each input of said second plurality being associated with a unique musical tone of a musical scale; wherein said control logic is further adapted to detect on said panel a user selection of one of said second plurality of user selectable inputs; and in response to said detecting a user selection of one of said second plurality of selectable inputs, play a musical tone through said audio output circuit wherein said musical tone is associated with said detected selected input of said second plurality of inputs.

17. The device of claim 16 wherein said panel further has a plurality of light emitting diodes and wherein said control logic is further adapted to, in response to said detecting a user selection of one of said second plurality of selectable inputs, causing each of said plurality of light emitting diodes to emit a pulse of light.

18. The device of claim 12 further a pouch disposed on said panel, said pouch having a comprising a flexible, at least partially transparent material, a fluid enclosed within said material and a plurality of objects floating within said pouch and at least partially visible to a user through said pouch.

19. The device of claim 12 wherein at least some of said objects have the shape of a musical note.

20. The device of claim 12 wherein at least some of said objects have the shape of a musical instrument.

21. The device of claim 12 further comprising a compressible material and a crinkle paper covering said compressible material and having a surface adapted to be touched by a user wherein in response to a user touch of said surface, said crinkle paper is adapted to flex and emit a crinkling sound.

22. The device of claim 16 wherein said panel has a third plurality of user selectable inputs, each input of said third plurality being associated with an individual wherein said control logic is further adapted to detect a user selection of an input of said third plurality of user selectable inputs and in response to said detecting a user selection of one of said third plurality of selectable inputs, play a recording of a voice through said audio output circuit wherein said voice is the voice of the individual associated with said detected selected input of said third plurality of inputs.

23. A device, comprising:
a foldable member adapted to be attached to a crib for an infant, said member having an audio output circuit,
a first plurality of user selectable inputs carried by said member, each input of said first plurality being associated with a unique musical style;
control logic carried by said member and adapted to detect a user selection of one of said first plurality of user selectable inputs, and in response to said detecting, play a musical segment through said audio output circuit wherein said musical segment has a musical style associated with said detected selected input.;
a second plurality of user selectable inputs carried by said member, each input of said second plurality being associated with a unique musical tone of a musical scale; wherein said control logic is further adapted to detect on said member a user selection of one of said second plurality of user selectable inputs; and in response to said detecting a user selection of one of said second plurality of selectable inputs, play a musical tone through said audio output circuit wherein said musical tone is associated with said detected selected input of said second plurality of inputs;
a plurality of light emitting diodes carried on said member wherein said control logic is further adapted to, in response to said detecting a user selection of one of said second plurality of selectable inputs, causing selected light emitting diodes to emit a pulse of light;
a pouch carried by said member and having a comprising a flexible, at least partially transparent material, a fluid enclosed within said material and a plurality of objects floating within said pouch and at least partially visible to a user through said pouch;
a compressible material carried by said member;
a crinkle paper covering said compressible material and having a surface adapted to be touched by a user wherein in response to a user touch of said surface, said crinkle paper is adapted to flex and emit a crinkling sound.; and
a third plurality of user selectable inputs carried by said member, each input of said third plurality being associated with an individual, wherein said control logic is further adapted to detect on said member a user selection of an input of said third plurality of user selectable inputs, and in response to said detecting a user selection of one of said third plurality of selectable inputs, play a recording of a voice through said audio output circuit wherein said voice is the voice of the individual associated with said detected selected input of said third plurality of inputs.
